(19) United States
(12) Patent Application Publication
(10) Pub. No.: US 2019/0152611 A1
(43) Pub. Date: May 23, 2019

(54) MEMBRANE FOR FITTING ON A PIPE IN ORDER TO OBTAIN AN AIR-CONDITIONING SPACE

(71) Applicants: Airbus Operations GmbH, Hamburg (DE); Airbus Operations SAS, Toulouse (FR)

(72) Inventors: Jean-Jacques Caussat, Toulouse (FR); Juraj Zamecnik, Hamburg (DE); Fabian Müller-Meiners, Hamburg (DE); Markus Kerber, Hamburg (DE)

(21) Appl. No.: 16/180,222

(22) Filed: Nov. 5, 2018

(30) Foreign Application Priority Data
Nov. 21, 2017 (DE) 10 2017 127 476.6

(51) Int. Cl. B64D 13/06

(52) U.S. Cl. CPC B64D 13/06; B64D 2013/003

(57) ABSTRACT

An air-distribution system has a first hollow body and a membrane. The first hollow body has a first air-conducting space. The membrane is fitted on the first hollow body in such a way that a second air-conducting space is formed. The second air-conducting space is enclosed by the membrane and an outer surface of the first hollow body. The method comprises the following steps: providing a membrane; fastening the membrane to a hollow body, with the result that there is obtained a second air-conducting space which is enclosed by the membrane and an outer surface of the hollow body.

### CROSS-REFERENCES TO RELATED APPLICATIONS

This application claims the benefit of the German patent application No. 10 2017 127 476.6 filed on Nov. 21, 2017, the entire disclosures of which are incorporated herein by way of reference.

### FIELD OF THE INVENTION

The invention relates generally to the technical field of air distribution and, in particular, to an air-distribution system having a membrane for fitting on a pipe in order to obtain a further air-conducting space, to an aircraft having such an air-distribution system, and to a method for producing an air-distribution system.

### BACKGROUND OF THE INVENTION

An object on which air-distribution systems are fundamentally based is that of feeding a defined quantity of air into a space. For this purpose, there is installed, for example, a pipe system consisting of a plurality of pipes and a holder system for supporting the pipe system. The installation of such an air-distribution system can be complicated particularly in complex and tight installation spaces.

For retrofitting an existing air-distribution system, either the existing air-distribution system is dismantled, and a new air-distribution system installed, or an additional stand-alone air-distribution system is installed. This retrofitting is associated with high costs and effort.

DE 10 2012 003 008 A1 and US 2014/349561 A1 disclose an exhaust-air system for an aircraft. The exhaust-air system has a pipe assembly in order to convey air.

### SUMMARY OF THE INVENTION

An object of the invention can be considered that of simplifying a retrofitting or expansion of an installed air-distribution system.

According to a first aspect of the invention, an air-distribution system having a first hollow body and a membrane is specified. The first hollow body has a first air-conducting space. The membrane is fitted on the first hollow body in such a way that a second air-conducting space is formed. The second air-conducting space is enclosed or formed by the membrane and at least one part of an outer surface of the first hollow body.

The first hollow body is open at its end faces but is otherwise of fluid-tight design and accordingly can also be referred to as a pipe. In principle, the pipe can have any desired cross section and can be composed, for example, of a plurality of longitudinal portions. The plurality of hollow bodies or longitudinal portions of hollow bodies which are in fluid (air) contact form an air-channeling system. This air-channeling system can also be referred to as an “existing” or “first” air-channeling system. A further fluid-conducting space is obtained by fitting the membrane on the first hollow body or on an outer surface of the first hollow body. This space can also be referred to as an “additional” or “second” air-channeling space or air-channeling system. The first air-channeling system and the second air-channeling system are not in fluid contact, that is to say, that what is concerned here are two stand-alone mutually separate air-channeling systems each having a fluid (air) source and a fluid (air) sink. However, embodiments having more than one additional air-channeling system are also possible. It is thus possible, for example, for a first membrane and a second membrane to be fitted on an outer surface portion of the first hollow body. The first membrane can be arranged next to the second membrane or even over the second membrane. Also conceivable are embodiments in which different air-channeling systems are in fluid contact with one another.

The air-conducting space of the second air-channeling system is formed by the membrane and a subregion of the outer skin of the hollow body. Here, the membrane can be designed to be either air-impermeable or air-permeable. The membrane material can be air-permeable, in which case the air diffuses through the membrane material. Alternatively or in addition, holes/slots or the like can be incorporated in the membrane.

According to one embodiment of the invention, the membrane is fitted on the first hollow body in such a way that two opposite edges of the membrane are spaced apart from one another along the outer surface of the first hollow body in a circumferential direction of the hollow body. The two opposite edges preferably extend parallel to the longitudinal axis of the first hollow body.

In principle, the membrane can, in an initial form (if the membrane is thus not yet fastened to the hollow body), be referred to as a planar two-dimensional structure, and can be present in the form of a rectangle, for example. Two opposite edges of this rectangular structure are then used to be fastened to the outer surface of the hollow body in the longitudinal direction thereof The other two edges of the membrane then form inlet or outlet of the space delimited by the membrane and the outer surface of the hollow body.

The membrane thus does not completely enclose the first hollow body in the circumferential direction. In the case of a circular cross section of the first hollow body, for example, the membrane can cover a circular arc with an opening angle of 180° or less.

According to a further embodiment of the invention, the air-distribution system has a seal which is fitted along the two opposite edges of the membrane. The seal can be designed as a rubber seal or silicone seal, for example. The seal can be fitted along the complete contact line of the membrane with the outer surface of the first hollow body or in certain portions along this contact line.

According to a further aspect of the invention, the seal is designed as an adhesive seal. Accordingly, the seal is additionally assigned the task of fixing the membrane on the first hollow body, with the result that further retaining means can be dispensed with.

According to a further aspect of the invention, the air-distribution system has a retaining element which fixes the membrane on the first hollow body. The retaining element engages around the membrane and the hollow body at least in certain portions in the circumferential direction and presses them against one another at least on the aforementioned contact line. The retaining element can be designed as a clamp. Furthermore, the retaining means can be designed as a hook and loop fastener.

According to a further aspect of the invention, the membrane has a bellows. This affords the advantage of the membrane having any desired curved portion along the first hollow body. A bellows can be particularly advantageous in the case of T-pieces or generally curved or right-angled pipe portions of the first hollow body. The functionality of the bellows corresponds to that of a toggle joint and allows folding or bending of the membrane in the longitudinal direction.

According to a further aspect of the invention, the membrane has a rigid region. This region can completely encompass the membrane, with the result that the membrane is designed as a type of “half-shell”. The material of the half-shell can be porous, with the result that the half-shell is without additional openings. The half-shell can preferably consist of customary plastics materials. The half-shell can furthermore consist of the same material as the first hollow body. A plurality of half-shells can be joined to one another in the longitudinal direction. In order to combine the individual half-shells to form a second air-distribution system, adapter pieces can be provided between the individual half-shells.

Furthermore, the rigid region can be realized by structural elements, such as bars, for example. The bars can be of flexible design and, in a force-flow-optimized manner, form in certain portions a type of skeleton for stabilizing the membrane. For example, the bars can be introduced into an edge region of the membrane and serve to reinforce the contact line with the first hollow body or to ensure a certain degree of dimensional stability in the longitudinal direction.

According to a further aspect of the invention, the membrane is a sheet. The sheet can consist of an or air-impermeable material.

The flexible sheet is, for example, fastened from a fabric impregnated in a solution (known as a material for thermoplastic pipes) to the first air-distribution system (the hollow body) with the aid of an adhesive strip in such a way that an additional air-conducting space is obtained. Where appropriate, this sheet is fastened by means of an application tool. It is alternatively also possible for marking, which lead to an exact mounting, to be applied to the first air-distribution system by means of a template, with the result that an equally sized space is always obtained.

According to a further aspect of the invention, the flexible sheet is fabric-reinforced. The fabric reinforcement can be implemented by applying a further layer and/or applying a coating.

According to a further aspect of the invention, the membrane has a C-profile in the mounted state. In the present case, a C-profile is to be understood as meaning a C-shaped or semicircular cross section of the membrane. The cross section can correspond to a circle sector or ellipse sector and, depending on the embodiment, the membrane can be of rigid or flexible design.

According to a further aspect of the invention, the membrane has at least one air outlet. The at least one air outlet can be realized in the form of an opening in the membrane. An opening can be circular (hole) or elongate (slot). Combinations thereof are also possible. The at least one air outlet can also be present in the form of an air-permeable membrane material, in which case the air diffuses through the membrane material.

According to a further aspect of the invention, an aircraft having an air-distribution system as described above and below is provided.

In an aircraft there are mounting and installation shafts in the overhead region of the passenger cabin, for example. Lines and pipes extend in these shafts. The installation space in aircraft in general and in the installation shafts is usually greatly limited. In addition, there are specifications as to how this installation space must be used. For example, there are specifications which determine a minimum spacing of the lines and pipes from walls of the installation shafts. These specifications serve to allow and to simplify the maintenance and inspection of the aircraft. However, these specifications often hamper subsequent conversions, in particular the addition of components, within the installation shaft. Added components could result in a falling-below of the minimum spacings.

The air-distribution system as described above and below can contribute to allowing an upgrading in an installation shaft. The membrane is fitted to the outer surface of an existing pipe and thus provides a second fluid-conducting space. During maintenance work, however, no fluid is conducted within the space formed by the membrane. The membrane thus does not limit the installation space in the installation shaft and can either be demounted from the existing pipe or simply pressed onto the outer surface of the pipe. It is conceivable that tabs are arranged on the membrane, these tabs making it possible to fasten the membrane to the outer surface of the pipe during maintenance work. For this purpose, hooks or other suitable projections can be arranged on the outer surface of the pipe.

The space defined by the membrane and the outer surfaces of the first hollow body can be used in the aircraft to distribute air in the passenger cabin or another space.

According to a further aspect of the invention, the air-distribution system is arranged to introduce air into an interior of the aircraft. The interior can be a maintenance shaft in the cabin; the air can thus be introduced or blown into the maintenance shaft. For example, the air can be blown in for dehumidification purposes. Dry air is conducted from the air source through the air-channeling system formed by the membrane and the outer surface of the first hollow body into the space to be dehumidified, the humidity being reduced as a result.

According to the invention, a method for producing an air-distribution system is provided. The method comprises the following steps: providing a membrane; fastening the membrane to a hollow body, with the result that there is obtained an air-conducting space which is enclosed by the membrane and an outer surface of the hollow body.

Here, the membrane is designed as described above and can in particular be installed in an aircraft in order to provide an additional fluid-conducting space in an installation shaft.

According to one aspect of the invention, the membrane is fastened to a pipe in an aircraft, as already described further above.

### BRIEF DESCRIPTION OF THE DRAWINGS

Exemplary embodiments of the invention will be described below with reference to the figures, in which:

FIG. 1 shows an air-distribution system according to one exemplary embodiment of the invention.

FIG. 2 shows an air-distribution system according to a further exemplary embodiment of the invention.

FIG. 3 shows an air-distribution arrangement according to a further exemplary embodiment of the invention.

FIG. 4 shows a method according to a further exemplary embodiment of the invention.

FIG. 5 shows an aircraft according to a further exemplary embodiment of the invention.

### DETAILED DESCRIPTION OF THE PREFERRED EMBODIMENTS

The illustrations in the figures are schematic and not true to scale.

Where identical reference numbers are used in the following description of the figures, these refer to identical or similar elements.

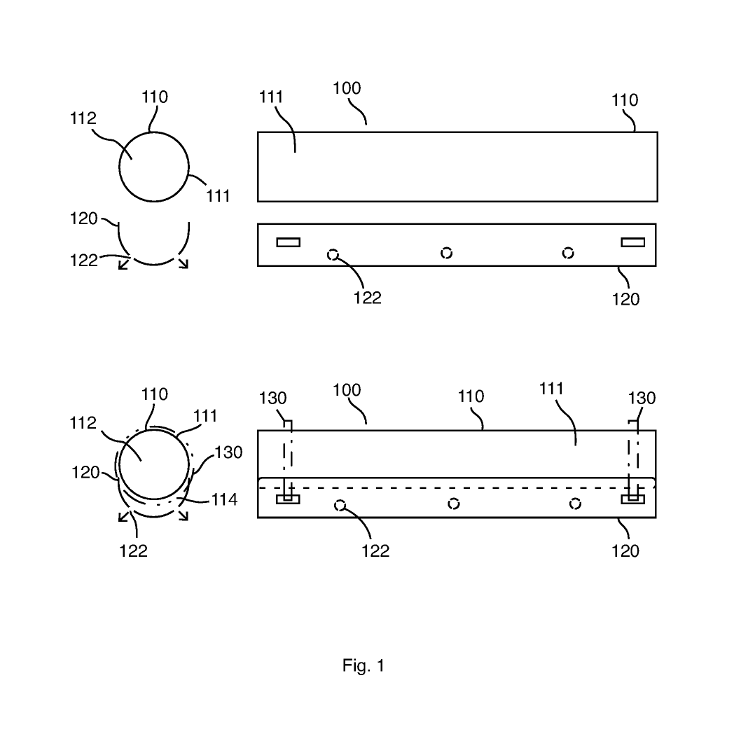

FIG. 1 shows an application example of an air-distribution system 100 having a first hollow body 110 and a membrane 120. In the upper illustration, the first hollow body 110 and the membrane 120 are illustrated as separate from one another, and in the lower illustration, the membrane 120 is mounted on the outer surface of the hollow body 110.

The first hollow body has a first air-conducting space 112, the membrane being fitted on the first hollow body 110 (on an outer surface of the hollow body 110) in such a way that a second air-conducting space 114 is formed. The second air-conducting space 114 is enclosed by the membrane 120 and a portion of the outer surface 111 of the first hollow body 110. The membrane 120 has a plurality of air outlets 122. To fasten the membrane 120, the membrane 120 is provided with apertures in the material. Other fastening means are also conceivable. A clamp 130 can be guided through the apertures in the material and the clamp 130 can then be placed around the first hollow body 110 in the circumferential direction of the first hollow body 110. This arrangement can also be referred to as a half-shell piggyback pipe. Here, the clamp 130 fixes the membrane 120 on the first hollow body 110 and secures the membrane 120 against sliding in the longitudinal direction and in the circumferential direction or a combination of the two directions. Furthermore, the clamp 130 is designed to counteract the weight force of the membrane 120.

The reversibility of this arrangement is particularly advantageous, in particular in terms of the possibility of a time- and cost-favorable mounting and demounting of the membrane on or from the hollow body. The clamp 130 can also be referred to as a strap. Not shown in the figure is a possible additional seal. This seal can be arranged as an additional element in the contact region of the first hollow body 110 and membrane 120 in such a way that air is prevented from being let out along the contact region. Furthermore, an expediently designed coating of the outer surface of the first hollow body 111 and/or the membrane 120 is also possible, which coating, with the two components abutting one another in the contact region, prevents air from being let out.

In this application example, the membrane 120 is of rigid design at least in certain portions and can be referred to as a half-shell. All statements pertaining to this application example apply analogously to an application example with a membrane 120 of flexible design.

The membrane 120 can be designed in the region of the contact lines with the outer surface of the hollow body 110 in such a way that sliding of the membrane on the hollow body is prevented in the fastened state (see lower illustration of FIG. 1). This can be achieved in that the membrane has, at least in the region of the contact lines, a correspondingly high coefficient of static friction. This coefficient of static friction can be achieved by a coating. The seal can also contribute to this coefficient of friction.

It is also conceivable that two longitudinal grooves or depressions in general, into which the edge regions of the membrane are pressed, are provided on the outer surface of the hollow body in the region of the contact lines. This can likewise prevent sliding of the membrane relative to the hollow body.

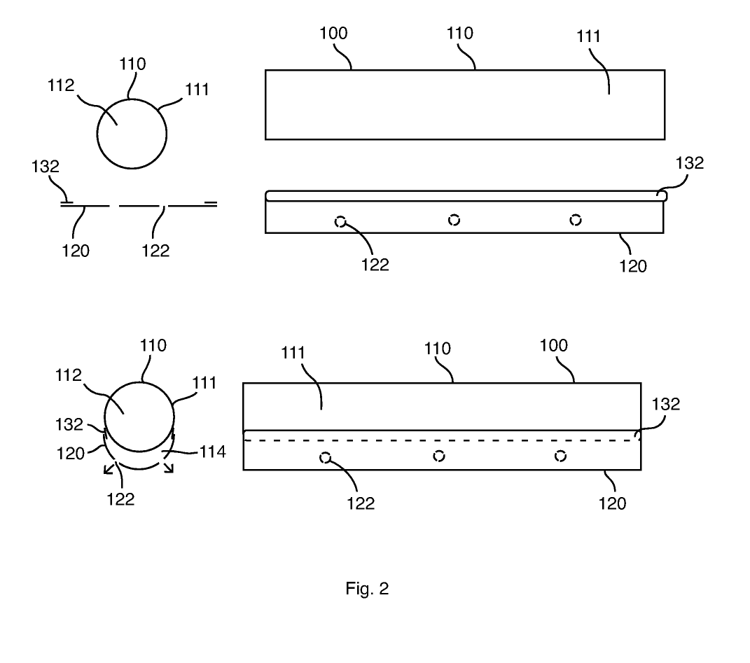

FIG. 2 shows, as a further option, an application example of an air-distribution system 100 having a first hollow body 110 and a membrane 120. The general statements of FIG. 1 also apply in an identical manner to the embodiment of FIG. 2.

The first hollow body has a first air-conducting space 112, the membrane 120 being fitted on the first hollow body 110 in such a way that a second air-conducting space 114 is formed. The second air-conducting space 114 is enclosed by the membrane 120 and an outer surface 111 of the first hollow body 110. The membrane 120 has a plurality of air outlets 122. By contrast with the above-described application example, the air-distribution system 100 has an adhesive seal 132. The functionality of the adhesive seal 132 comprises, on the one hand, the sealing of the contact regions of the first hollow body 110 and membrane 120 and, on the other hand, structurally holding together the first hollow body 110 and the membrane 120. In the design of the adhesive strips, it is accordingly possible to pay heed to the loading cases through the intrinsic weight of the membrane 120, and also internal pressures and temperature fluctuations.

The properties of the air-distribution systems from FIG. 1 and FIG. 2 can be combined as desired.

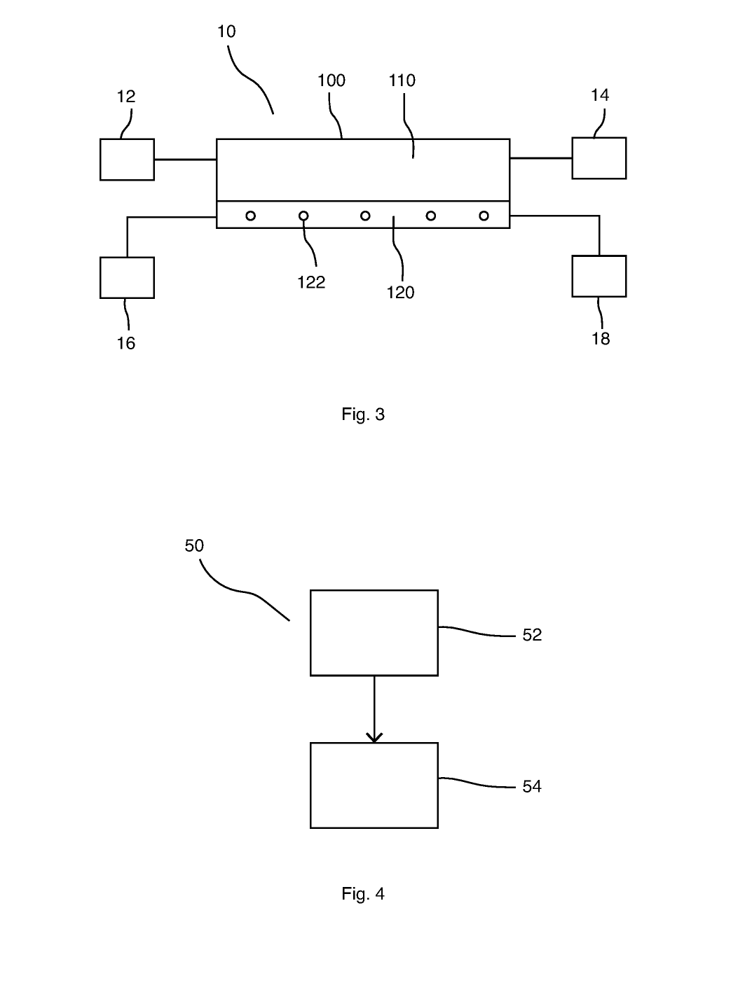

FIG. 3 shows an air-distribution arrangement 10. The air-distribution arrangement 10 has an air-distribution system 100 having a first hollow body 110 and a membrane 120. The air-distribution system is an air-distribution system 100 as described further above and below. The first hollow body 110 has a first air-conducting space 112, the membrane 120 being fitted on the first hollow body in such a way that a second air-conducting space 114 is formed. The second air-conducting space 114 is enclosed by the membrane 120 and an outer surface 111 of the first hollow body 110. The membrane 120 has a plurality of air outlets 122.

In addition to the air-distribution system 100, the air-distribution arrangement 10 has further peripheral devices. The first hollow body 110 is connected to a first air source 12 and a first air sink 14, with the result that air can be conveyed through the first air-conducting space 112. The second air-conducting space 114, which is formed by an outer surface of the hollow body 111 and the membrane 120, is connected to a second air source 16 and a second air sink 18.

In an example which is not shown, the two pairs of air source and air sink 12, 14, on the one hand, and 16, 18, on the other hand, can each form an air circuit. For this purpose, a pump unit is necessary in the air circuit. Application examples are also possible in which the air-conducting spaces 112, 114 are in fluid contact and thus only one air source and one air sink or only one air circuit is necessary.

It is conceivable that the second air sink 18 is not present and that only air is introduced into the fluid space formed by the membrane. Since the membrane 120 has air outlets or is generally designed, an additional air sink is not necessary. For this purpose, the right-hand outlet of the air space 114 can be closed, for example in that the membrane 120 is likewise closed fluid-tight with the outer surface of the hollow body 110 at this point.

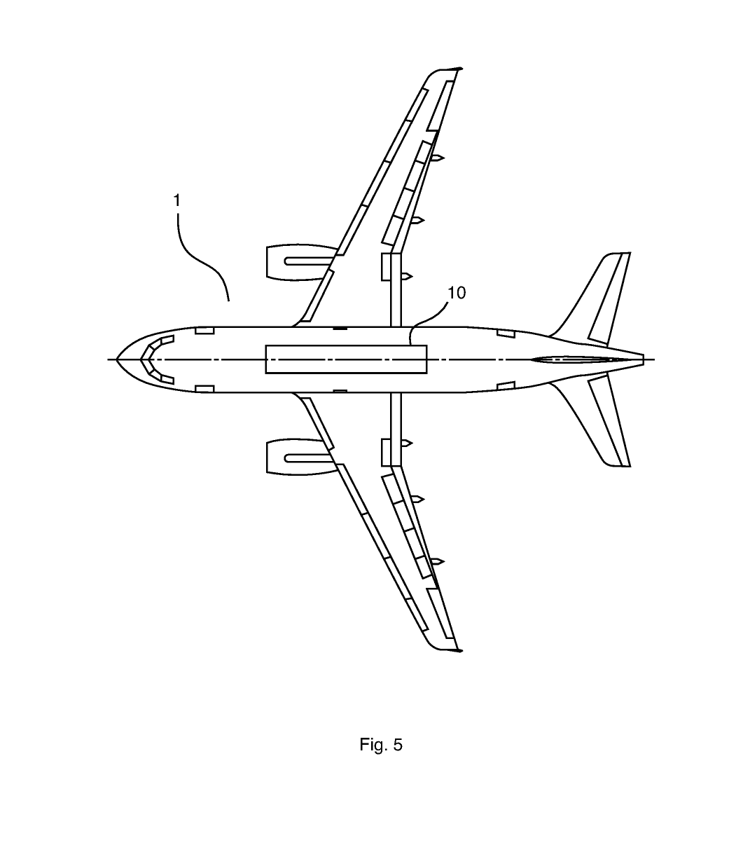

FIG. 4 shows the steps of a method 50 for producing an air-distribution system. The method comprises the following steps: providing 52 a membrane 120; fastening 54 the membrane 120 to a hollow body 110, with the result that there is obtained a second air-conducting space 114 which is enclosed by the membrane 120 and an outer surface of the hollow body 111. Here, the membrane 120 is designed as described above. The method serves to produce an air-distribution system as described above and below.

FIG. 5 shows an aircraft 1 having an air-distribution arrangement 10. The air-distribution arrangement 10 is shown in FIG. 4. The air-distribution arrangement 10 having the air-distribution system 100 as described above makes it possible to retrofit existing aircraft and in so doing take account of requirements placed on an installation shaft. A possible application example is described below.

The specific case of integrating an air-drying system (dry air generation system) and also, in particular, retrofitting such a system in existing aircraft is made more difficult by the fuselage surroundings (consisting of structural components, other systems, devices and electric wire bundles) to the effect that the installation space for integrating an additional system is initially not present. When creating this installation space, it is necessary to observe fixed spacing rules. Here, high costs arise through the laying of the surrounding components, cable bundles and devices. Air can intentionally emerge at a plurality of points and lead to as uniform as possible a distribution of the dry air in the interior. The leakage rate (also leak rate) is a measure of the volume or mass units emerging from a body. These high leakage rates arise by virtue of defined holes out of which dry air flows.

The air-distribution system is not restricted to the use as a dry air generation system. In general, the air-distribution system according to the invention can be used in all application cases in which the fluid to be conveyed has an overpressure in relation to the surroundings.

The combination of two air-conducting systems (hollow body and membrane) means that it is possible to save on material to the extent that the outer skin of the one pipe can be partially used as a delimitation for the other system.

The means for holding the existing pipe system can also be used and requires no modification because the membrane has a low weight.

In particular, this arrangement can be efficiently used as a retrofitting kit in an existing aircraft. The advantage of the present application is the utilization of an installation space which cannot be used in a conventional design on account of existing spacing rules.

All the application examples are also conceivable with fluids other than air.

The above-described exemplary embodiments can be combined in a variety of ways. In particular, aspects of the method can also be used for embodiments of the devices and use of the devices, and vice versa.

In addition, it should be pointed out that “comprising” does not exclude other elements or steps and “one,” “a” or “an” does not exclude a plurality. It should also be pointed out that features or steps which have been described with reference to one of the above exemplary embodiments can also be used in combination with other features or steps of other above-described exemplary embodiments. Reference signs in the claims are not to be considered as a limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Aircraft
10 Air-distribution arrangement
12 First air source
14 First air sink
16 Second air source
18 Second air sink
100 Air-distribution system
110 First hollow body
111 Outer surface of the first hollow body
112 First air-conducting space
114 Second air-conducting space
120 Membrane
122 Air outlet
130 Clamp
132 Adhesive seal

1. An air-distribution system, having:
a first hollow body;
a membrane;
wherein the first hollow body has a first air-conducting space,
wherein the membrane is fitted on the first hollow body in such a way that a second air-conducting space is formed,
wherein the second air-conducting space is enclosed by the membrane and an outer surface of the first hollow body.

2. The air-distribution system according to claim 1, wherein the membrane has at least one air outlet.

3. The air-distribution system according to claim 1, wherein the membrane is fitted on the first hollow body in such a way that two opposite edges of the membrane are spaced apart from one another along the outer surface of the first hollow body in a circumferential direction.

4. The air-distribution system according to claim 3, further comprising a seal which is fitted along the two opposite edges of the membrane.

5. The air-distribution system according to claim 4, wherein the seal is designed as an adhesive seal.

6. The air-distribution system according to claim 1, further comprising a retaining element which fixes the membrane on the first hollow body.

7. The air-distribution system according to claim 1, wherein the membrane has a bellows.

8. The air-distribution system according to claim 1, wherein the membrane has a rigid region.

9. The air-distribution system according to claim 1, wherein the membrane is a flexible sheet.

10. The air-distribution system according to claim 9, wherein the flexible sheet is fabric-reinforced.

11. The air-distribution system according to claim 1, wherein the membrane has a C-profile.

12. An aircraft having an air-distribution system according to claim 1.

13. The aircraft according to claim 12, wherein the air-distribution system is arranged to introduce air into an interior of the aircraft.

14. A method for producing an air-distribution system, comprising the following steps:
providing a membrane;
fastening the membrane to a hollow body, with a result that there is obtained a second air-conducting space which is enclosed by the membrane and an outer surface of the hollow body.

15. The method according to claim 14, wherein the membrane is fastened to a pipe in an aircraft.
